(19) United States
(12) Patent Application Publication
(10) Pub. No.: US 2008/0218397 A1
(43) Pub. Date: Sep. 11, 2008

(54) Slide action remote control with display

(76) Inventors: Edward J. Zylka, Lake Forest, IL (US); James H. Grotelueschen, Glen Ellyn, IL (US); Michael F. De Rossi, Lindenhurst, IL (US); Timothy James Morton, Austin, TX (US)

Correspondence Address: Thomas G. Scavone;Niro, Scavone, Haller & Niro, Suite 4600, 181 W. Madison, Chicago, IL, 60602, US

(21) Appl. No.: 11/715,272

(22) Filed: Mar. 7, 2007

(51) Int. Cl. H04L 17/02

(52) U.S. Cl. 341/176

(57) ABSTRACT

A hand held apparatus for remotely controlling consumer electronics appliances comprises an upper housing having top and bottom surfaces and a lower housing having top and bottom surfaces, with the bottom surface of the upper housing and the top surface of the lower housing being slidably engaged to permit the lower housing to move relative to the upper housing between closed and open positions. The remote control also has a display located in the top surface of the upper housing for presenting an image relevant to the control or operation of the remote control itself or the controlled appliances; a first set of tactile input devices located in the top surface of the upper housing and including an input device for interacting with the displayed image; and a second set of tactile input devices located in the top surface of the lower housing. The two housings may move relative to one another so that the second set of input devices is covered by the top housing when the lower housing is in the closed position and is uncovered when the lower housing is in the open position.

### BACKGROUND OF THE INVENTION

The present invention relates generally to hand held devices for remotely controlling consumer electronics appliances and, more particularly, to a universal remote control device useful in operating TVs, DVD players, and other media or home entertainment equipment.

In recent years, there has been substantial development and enhancement of home video and audio equipment, with multiple TVs, DVD players and digital video recorders becoming commonplace in the home, office and retail stores. There has likewise been a great number of remote control devices introduced to the market, having a wide variety of utilities and functions. These remote control devices have become increasingly complex and often require an imposing array of keys and buttons to permit their full utilization. More recently, remote controls have been introduced having displays to provide information to the user to facilitate use of both the remote control itself and the various controlled appliances. However, the display necessarily requires sufficient space on the remote control to make the displayed images easily read or otherwise recognized, and this further exacerbates the already crowded condition on the remote due to the large number of keys and buttons as previously noted.

Therefore, a need exists for a new hand held remote control design that permits the use of a relatively large display and still may accommodate a large number of operational input devices, such as keys, button, rollers and joy sticks. Moreover, a need exists for such a remote control that is still relatively small so that it is ergonomically adequate; that is, it is small enough to be easily hand held and operated most preferably with one hand.

### SUMMARY OF THE INVENTION

The present invention is directed to a hand held apparatus for remotely controlling media or home entertainment or other consumer electronics appliances. The appliances controlled with the apparatus may include TVs, DVD players, digital recorders, set top boxes, and various audio equipment. The remote control of the present invention comprises an upper housing having top and bottom surfaces and a lower housing having top and bottom surfaces, with the bottom surface of the upper housing and the top surface of the lower housing being slidably engaged to permit the lower housing to move relative to the upper housing between closed and open positions. The remote control also has a display located in the top surface of the upper housing for presenting an image relevant to the control or operation of the remote control itself or the controlled appliances; a first set of tactile input devices located in the top surface of the upper housing and including an input device for interacting with the displayed image; and a second set of tactile input devices located in the top surface of the lower housing. The two housings may move relative to one another so that the second set of input devices is covered by the top housing when the lower housing is in the closed position and is uncovered when the lower housing is in the open position.

### BRIEF DESCRIPTION OF THE DRAWINGS

The novel features which are characteristic of the present invention are set forth in the appended claims. However, the invention's preferred embodiments, together with its attendant advantages, will be best understood by reference to the following detailed description taken in connection with the accompanying drawings in which:

FIG. 1 is a perspective view illustrating one preferred embodiment of a remote control made in accordance with the teachings of the present invention and showing the remote control in the closed position;

FIGS. 2 and 3 are perspective views illustrating the operation of one form of roller input device useful in the embodiment illustrated in FIG. 1;

FIG. 4 is a plan view of the embodiment of FIG. 1 showing the remote control in an open position;

FIG. 5 is a cross section view taken along line 5-5 of FIG. 4; and FIG. 6 is a cross section view taken along line 6-6 of FIG. 5.

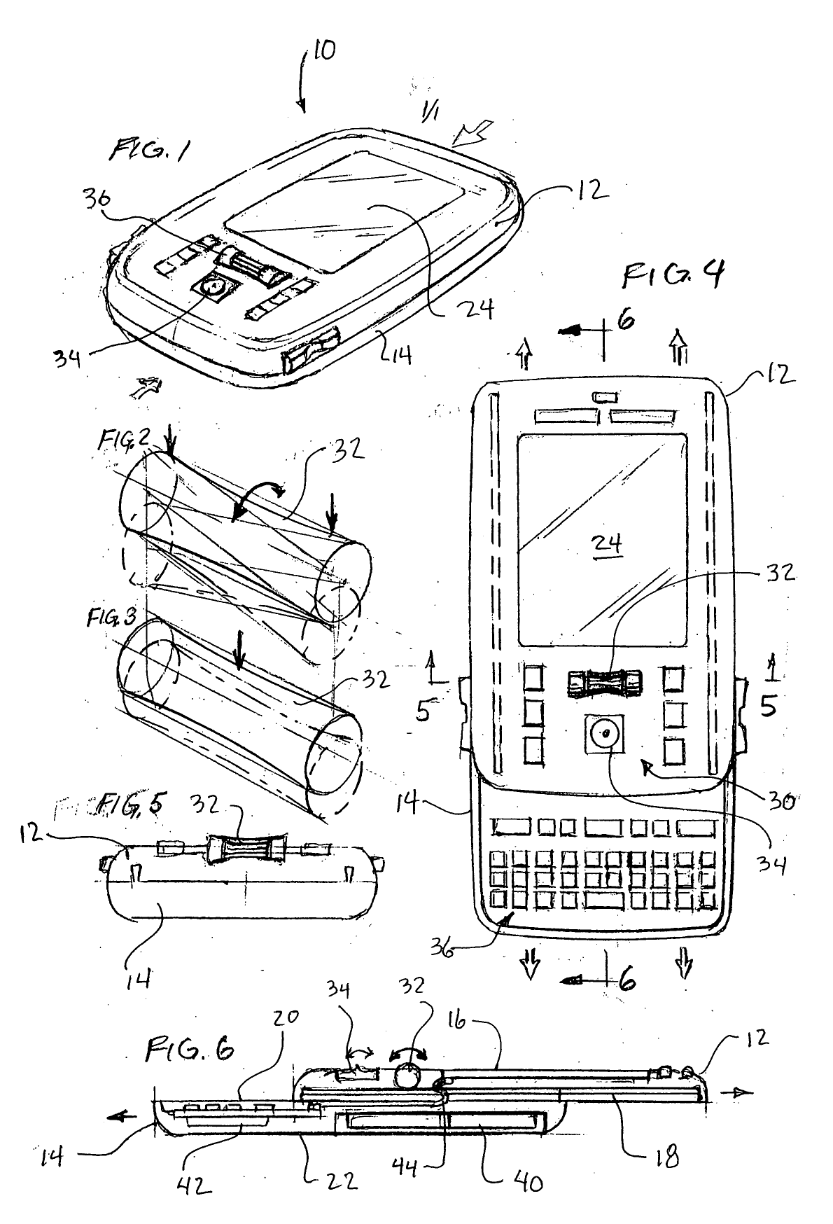

### DETAILED DESCRIPTION OF THE PREFERRED EMBODIMENTS

With reference to the drawings, one preferred embodiment of the present invention is illustrated in the form of a hand held apparatus 10 used to remotely control various media or home entertainment or other consumer electronics appliances. The remote control 10 is constructed with an upper housing 12 and a lower housing 14. Each of the two housings has a top surface, 16 and 20 respectively, and a bottom surface, 18 and 22 respectively. The bottom surface 18 of the upper housing and the top surface 20 of the lower housing slidably engage one another to permit the lower housing to move relative to the upper housing between a closed position and an open position. Each of the housings may be fitted with mating tracks or rails 21 that allow the lower housing to slide between the open and closed positions.

As illustrated in the preferred embodiment, the lower housing 14 slides up and down or longitudinally relative to the upper housing 12. However, the lower housing may also slide to the side or laterally, or may even rotate relative to the upper housing between the closed and open positions.

A display 24 is located in the top surface 16 of the upper housing. The display may present a variety of images, including program guides, advertising, and other images relating to the operation of the remote control itself or one or more of the controlled appliances, such as a TV. A first set or array of tactile input devices 30 is also located in the top surface 16 of the upper housing. This first set of input devices preferably includes at least one input device used to control or interact with the image presented on display 24. Most preferably, this display related input device is a “five way” key, such as roller key 32. Such a roller key is well known to those of skill in the art and allows the user to navigate up and down on the display as well as to the right and left. It also allows the user to make a selection from the displayed image. It is also preferred that the first set of input devices 30 include a second “five way” key 34 which permits the user to control or interact with one or more of the controlled appliances. Most preferably, key 34 will take a form different from that of key 32 and in the illustrated embodiment this second key 34 is a joy stick also well known to those of skill in the art. The first set of input devices 30 may also include so-called “soft” keys or other keys used in the conventional operation of the remote control 10 or the controlled appliances.

In accordance with the preferred embodiment of the present invention, the size of the hand held remote control 10 is kept to a minimum, to facilitate one handed use of the device, while the size of the display 24 relative to the overall size of the remote control 10 is maximized to enhance the visual presentation on the display. Preferably, the display 24 will have longitudinal and lateral dimensions greater than one-half the overall longitudinal and lateral dimensions of the remote control.

In order to accommodate these desired size and dimensional constraints and to provide a clean and uncluttered appearance to the remote control, a second set of tactile input devices 36 is located in the top surface 20 of lower housing 14 rather than on the upper housing. This second set of input devices or keys is arranged so they are covered by the top housing 12 when the lower housing is in the closed position and uncovered and accessible to the user when the lower housing is in the open position.

The lower housing may also incorporate or house various components necessary to the operation of the remote control, including, for example, the battery compartment 40 and the microprocessor and memory chips and other related electronic circuitry 42. A flexible cable 44 provides the necessary electrical communication between the upper and lower housings.

The remote control 10 also has an infra red transponder and a radio frequency transceiver and related circuitry to permit communication with the various controlled appliances and other external communication networks, such as the internet. All of these components are very well known to those of skill in the art and need not be described in detail here. In a preferred embodiment, the remote control has WiF capability to permit internet communication simultaneously with the control of the various in home appliances. With the additional input device capacity of the present invention, the device can be used to access, read or compose electronic messages or other data. In addition, other information services available via the internet may also be accessed.

It will be appreciated by those of skill in the art that various changes and modifications can be made to the illustrated embodiments without departing from the spirit of the present invention. All such changes and modifications are intended to be covered by the appended claims which follow.

We claim:

1. A hand held apparatus for remotely controlling one or more consumer electronics appliances, comprising:
an upper housing having top and bottom surfaces;
a lower housing having top and bottom surfaces;
the bottom surface of the upper housing and the top surface of the lower housing being slidably engaged to permit the lower housing to move relative to the upper housing between closed and open positions;
a display located in the top surface of the upper housing for presenting images relevant to the control or operation of at least one of the consumer electronics appliances;
a first set of tactile input devices located in the top surface of the upper housing and including at least one input device for interacting with the displayed image;
a second set of tactile input devices located in the top surface of the lower housing; and
wherein the second set of input devices is (a) at least partially covered by the top housing when the lower housing is in the closed position and (b) uncovered when the lower housing is in the open position.

2. The hand held remote control apparatus of claim 1 wherein the top surface of the upper housing has a length and a width and the display has a length more than one-half the top surface length and a width more than one-half the top surface width.

3. The hand held remote control apparatus of claim 1 wherein the display interacting input device is a five way control key device.

4. The hand held remote control apparatus of claim 1 wherein the display interacting input device is a five way control roller device.

5. The hand held remote control apparatus of claim 1 wherein the first set of tactile input devices also includes at least one input device for interacting with a controlled appliance.

6. The hand held remote control apparatus of claim 1 wherein the upper and lower housings move relative to one another along a longitudinal axis of the housings.

7. The hand held remote control apparatus of claim 1 wherein the upper and lower housings move relative to one another along a lateral axis of the housings.

8. The hand held remote control apparatus of claim 1 wherein the upper and lower housings move rotationally relative to one another.

9. The hand held remote control apparatus of claim 1 further including a radio frequency transceiver to permit access to the internet and display of images received via the internet.
